(19) United States
(12) Patent Application Publication
(10) Pub. No.: US 2013/0024073 A1
(43) Pub. Date: Jan. 24, 2013

(54) COLLISION DAMAGE MITIGATION SYSTEM OF VEHICLE AND CONTROL METHOD THEREOF

(71) Applicant: Young Seop SON, (US)

(72) Inventor: Young Seop SON, (US)

(21) Appl. No.: 13/529,614

(22) Filed: Jun. 21, 2012

(30) Foreign Application Priority Data
Jun. 21, 2011 (KR) 10-2011-0060377

(51) Int. Cl. B60R 21/0134

(52) U.S. Cl. 701/45

(57) ABSTRACT

Disclosed are a collision damage mitigation system of a vehicle and a control method thereof. The collision damage mitigation system includes a forward sensor to detect a distance and relative speed between an owner's vehicle and a vehicle in front thereof, an electronic control unit to judge a degree of collision risk based on a Time-To-Collision (TTC) value upon receiving sensor information transmitted from the forward sensor, the TTC value being obtained by dividing the distance between the owner's vehicle and the vehicle in front thereof by the relative speed therebetewen, and to control implementation of at least one of collision warning, vehicle control, and inflation of an air bag based on the judged degree of collision risk, and an air bag drive unit to inflate the air bag, immediately before vehicle collision, in response to an air bag inflation signal from the electronic control unit.

### CROSS-REFERENCE TO RELATED APPLICATION

This application claims the benefit of Korean Patent Application No. 10-2011-0060377, filed on Jun. 21, 2011, in the Korean Intellectual Property Office, the disclosure of which is incorporated herein by reference.

### BACKGROUND

1. Field

Embodiments of the present invention relate to a collision damage mitigation system of a vehicle and a control method thereof.

2. Description of the Related Art

In general, vehicle accidents frequently occur when a driver does not pay attention during driving of a vehicle or when a vehicle in front stops suddenly. To reduce such accidents, a collision damage mitigation system has been developed. The collision damage mitigation system is devised to detect a distance between a vehicle to which a radar is installed and another vehicle in front thereof and a relative speed therebetween so as to judge a degree of collision risk between the two vehicles, and based on the degree of risk of collision, to warn a driver of collision risk or implement automatic braking as necessary.

However, a conventional collision damage mitigation system may not be able to reduce damage to vehicles when a vehicle collision occurs, although it may mitigate shock damage to drivers.

### SUMMARY

Therefore, it is an aspect of the present invention to provide a collision damage mitigation system of a vehicle, in which, in addition to judging a degree of collision risk and implementing warning and braking control in stages based on the degree of collision risk, an air bag mounted to the exterior of a vehicle is inflated immediately before collision between vehicles based on a detected signal from a radar sensor so as to mitigate shock applied to the vehicles and drivers upon vehicle collision, thereby reducing damage to the vehicles and the drivers to the maximum extent, and a control method thereof.

Additional aspects and/or advantages will be set forth in part in the description which follows and, in part, will be obvious from the description, or may be learned by practice of the invention.

In accordance with one aspect of the invention, a collision damage mitigation system of a vehicle includes a forward sensor to detect a distance and relative speed between an owner's vehicle and a vehicle in front thereof, an electronic control unit to judge a degree of collision risk based on a Time-To-Collision (TTC) value upon receiving sensor information transmitted from the forward sensor, the TTC value being obtained by dividing the distance between the owner's vehicle and the vehicle in front thereof by the relative speed therebetewen, and to control implementation of at least one of collision warning, vehicle control, and inflation of an air bag based on the judged degree of collision risk, and an air bag drive unit to inflate the air bag, immediately before collision between the owner's vehicle and the vehicle in front thereof occurs, in response to an air bag inflation signal for inflation of the air bag from the electronic control unit.

In accordance with another aspect of the invention, a control method of mitigating collision damage to a vehicle includes detecting a distance and relative speed between an owner's vehicle and a vehicle in front thereof using a forward sensor, judging, by an electronic control unit, a degree of collision risk based on a Time-To-Collision (TTC) value obtained from sensor information detected by the forward sensor, wherein the TTC value is obtained by dividing the distance between the owner's vehicle and the vehicle in front thereof by the relative speed therebetween, warning a driver of collision risk between the owner's vehicle and the vehicle in front thereof using a warning unit based on the degree of collision risk judged by the electronic control unit, controlling, by the electronic control unit, the operation of the warning unit and a braking operation of a brake unit to brake the owner's vehicle based on the degree of collision risk judged by the electronic control unit, and inflating an air bag while implementing at least one of the warning operation of the warning unit and the braking operation of the brake unit based on the degree of collision risk judged by the electronic unit.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is a block diagram showing a configuration of a collision damage mitigation system of a vehicle according to an exemplary embodiment of the present invention;

FIG. 2 is a flowchart showing a control method of mitigating collision damage to a vehicle according to an exemplary embodiment of the present invention; and

FIG. 3 is a graph showing sequential stages of mitigating collision damage depending on a degree of collision risk according to an exemplary embodiment of the present invention.

### DETAILED DESCRIPTION

Reference will now be made in detail to exemplary embodiments of the present invention, examples of which are illustrated in the accompanying drawings, wherein like reference numerals refer to like elements throughout.

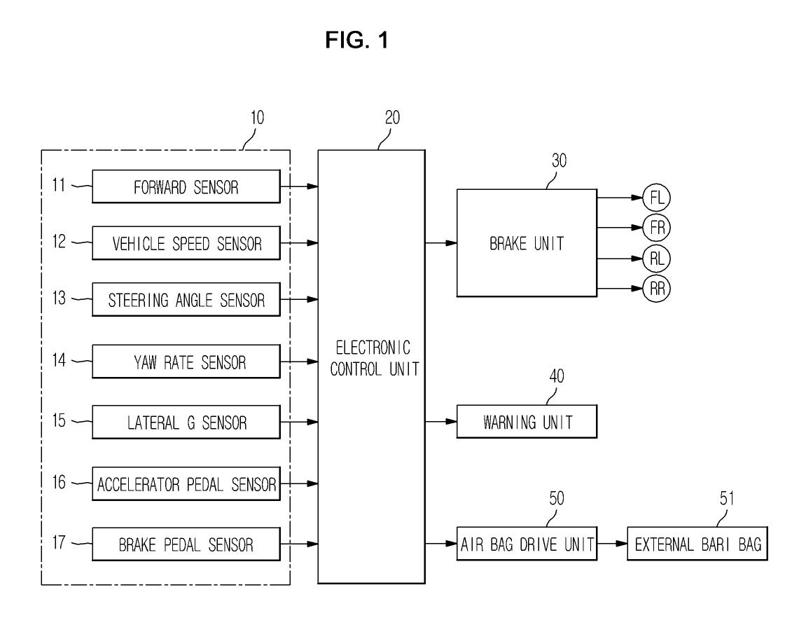

FIG. 1 is a block diagram showing a configuration of a collision damage mitigation system of a vehicle according to an exemplary embodiment of the present invention.

In FIG. 1, the collision damage mitigation system of a vehicle according to the exemplary embodiment of the present invention includes a sensing unit 10, an electronic control unit 20, a brake unit 30, a warning unit 40, and an air bag drive unit 50.

The sensing unit 10 detects a variety of vehicle sensor information. The sensing unit 10 includes a forward sensor 11, a vehicle speed sensor 12, a steering angle sensor 13, a yaw rate sensor 14, a lateral G sensor 15, an accelerator pedal sensor 16, and a brake pedal sensor 17.

The forward sensor 11 is mounted to the front of a vehicle, and includes a variety of known sensors, such as a radar sensor, camera sensor, etc. The forward sensor 11 detects a distance between an owner's vehicle and another vehicle in front thereof, and a relative speed and a relative acceleration therebetween, and transmits the detected results to the electronic control unit 20.

The vehicle speed sensor 12 is installed to each of vehicle wheels FL, RR, RL and FR to detect a longitudinal speed of the vehicle depending on a wheel speed, and to transmit the detected result to the electronic control unit 20.

The steering angle sensor 13 detects a degree of steering of a vehicle and transmits the detected result to the electronic control unit 20.

The steering angle sensor 13 is mounted to a lower end of a steering wheel and detects a steering angle of the steering wheel when a driver operates the steering wheel to turn a vehicle in a given direction. The steering angle sensor 13 also detects a steering speed and steering direction of the steering wheel.

The steering angle sensor 13 may be of an optical device type in which a slit plate of the sensor is rotated during steering to transmit or intercept light of an optical device, causing voltage change. The electronic control unit 20 may calculate the steering speed, steering direction and steering angle of the steering wheel based on the voltage change transmitted from the steering angle sensor 13.

The yaw-rate sensor 14 detects the yaw rate (turning speed) of a vehicle and transmits the detected result to the electronic control unit 20.

When a vehicle is turned with respect to a vertical axis thereof, i.e. when a vehicle is turned about the Z-axis, the yaw rate sensor 14 electronically detects the yaw moment of the vehicle via vibration of a plate fork inside the yaw rate sensor. Here, the yaw moment is inward or outward movement force caused when a vehicle body is turned in a leftward or rightward direction.

The yaw rate sensor 14 contains cesium crystals to generate voltage by rotation of the crystals when a vehicle is turned.

The lateral G sensor 15 is a two-axis acceleration sensor, which detects the lateral acceleration of a vehicle that is lateral push force applied to a vehicle during traveling, and transmits the detected lateral acceleration to the electronic control unit 20.

The accelerator pedal sensor 16 detects whether or not an accelerator pedal is operated and transmits the detected result to the electronic control unit 20.

The brake pedal sensor 17 detects whether or not a brake pedal is operated and transmits the detected result to the electronic control unit 20.

The electronic control unit 20 judges a degree of collision risk based on a variety of sensor information, more particularly, a relative speed and relative distance between an owner's vehicle and another vehicle in front thereof transmitted from the sensing unit 10, and controls implementation of collision warning and automatic braking based on the judged degree of collision risk in stages.

Further, the electronic control unit 20 determines a brake assist magnitude corresponding to the judged degree of collision risk, and controls brake force of the brake unit 30 based on the determined brake assist magnitude.

In addition to the above-described method, to more surely mitigate shock applied to vehicles and drivers upon vehicle collision, the electronic control unit 20 may control operation of an air bag mounted to the exterior of a vehicle such that the air bag is inflated immediately before collision between vehicles, thereby mitigating damage to the vehicles and drivers to the maximum extent possible even if vehicle collision occurs.

To this end, the electronic control unit 20 stores preset control stages depending on the degree of collision risk based on a Time-To-Collision (TTC) value that is obtained by dividing a distance between an owner's vehicle and another vehicle in front thereof by a relative speed therebetween. The stage of inflating the air bag mounted to the exterior of the vehicle corresponds to the fifth stage having the highest degree of collision risk.

The brake unit 30 generates brake force to prevent vehicle collision by controlling the pressure of brake fluid supplied to a wheel cylinder in response to a brake signal output from the electronic control unit 20.

The warning unit 40 warns of collision in stages by displaying a warning light, outputting a warning sound, or generating vibration in response to a warning signal output from the electronic control unit 20, thereby assisting the driver in recognizing collision risk.

The air bag drive unit 50 inflates an air bag (51, hereinafter, referred to as an external air bag) mounted to the exterior of the vehicle immediately before vehicle collision in response to a drive signal output from the electronic control unit 20, so as to mitigate shock of vehicle collision.

Generally, air bags for a vehicle are mainly mounted inside the vehicle to mitigate shock caused when a passenger collides with a vehicle body or other high-strength parts. These air bags mounted inside the vehicle include a driver seat air bag, a passenger seat air bag, a curtain air bag, a seat side air bag, etc.

However, a recent trend is to mount the external air bag 51 in order to mitigate shock applied when a vehicle collides with an obstacle (more particularly, another vehicle).

The external airbag 51 is installed in a space between a vehicle body and the rear of a bumper and is inflated forward immediately before a vehicle collides with an obstacle (more particularly, another vehicle) so as to absorb shock caused upon vehicle collision, thereby more surely mitigating damage to the vehicles and drivers.

Hereinafter, operations and effects of the collision damage mitigation system of the vehicle having the above-described configuration and a control method thereof will be described.

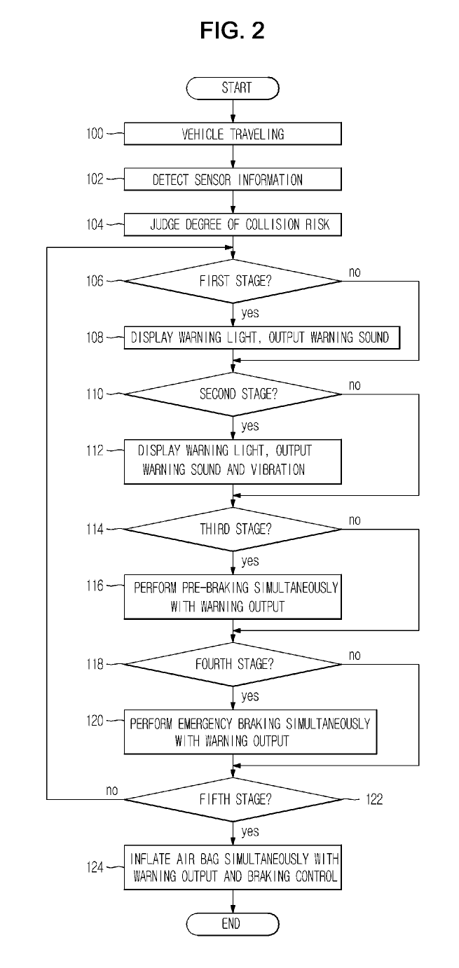

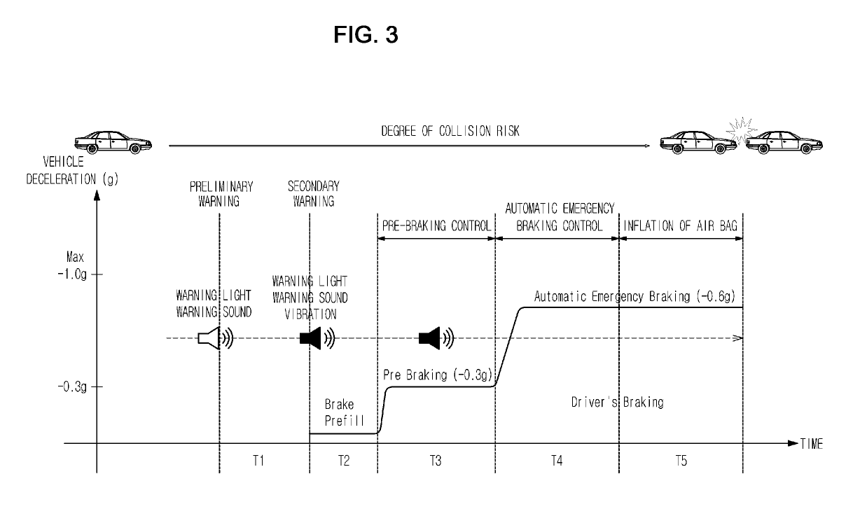

The collision damage mitigation system of the vehicle according to the embodiment of the present invention may perform warning a driver of collision, vehicle control, and inflation of the external air bag 51 in stages. In relation to these basic operations, collision is defined based on a TTC value obtained by dividing a distance between an owner's vehicle and another vehicle in front thereof by a relative speed therebetween, and based on the defined collision, there are given five stages corresponding to the degree of collision risk. This will be described with reference to FIGS. 2 and 3.

FIG. 2 is a flowchart showing a control method of mitigating collision damage to a vehicle according to an exemplary embodiment of the present invention, and FIG. 3 is a graph showing sequential stages of mitigating collision damage depending on a degree of collision risk according to an exemplary embodiment of the present invention.

In FIG. 2, during vehicle traveling (100), a distance, relative speed, and relative acceleration between an owner's vehicle and another vehicle in front thereof are detected using the forward sensor 11, such as a radar sensor, camera sensor, etc., installed to the front of the owner's vehicle, and the detected results are transmitted to the electronic control unit 20.

Also, the vehicle speed sensor 12, the steering angle sensor 13, the yaw rate sensor 14, and the lateral G sensor 15 respectively detect the longitudinal speed, steering angle, yaw rate(turning speed), lateral acceleration of the vehicle, and the detected results are transmitted to the electronic control unit 20 (102).

Accordingly, the electronic control unit 20 judges a degree of collision risk based on a variety of sensor information, more particularly, based on a TTC value obtained by dividing a distance between the owner's vehicle and another vehicle in front thereof by the relative speed therebetewen (104). In this case, the degree of collision risk is preset to five stages (first to fifth stages) within the electronic control unit 20 based on the TTC value obtained by dividing the distance between the owner's vehicle and another vehicle in front thereof by the relative speed therebetween.

The electronic control unit 20 judges whether or not the degree of collision risk corresponds to the first stage in which the TTC value is T1 or less (106). In the case of the first stage in which the TTC value is T1 or less, the electronic control unit 20 judges that the degree of collision risk is low, and outputs a first stage warning signal that indicates of collision risk to the warning unit 40.

Thereby, the warning unit 40, as shown in FIG. 3, primarily warns a driver to assist the driver in recognizing collision risk by displaying a warning light and outputting a warning sound in response to the first stage warning signal output from the electronic control unit 20 (108).

Subsequently, the electronic control unit 20 judges whether or not the degree of collision risk corresponds to the second stage in which the TTC value is T2 or less (110). In the case of the second stage in which the TTC value is T2 or less, the electronic control unit 20 judges a higher degree of collision risk than the first stage, and outputs a second stage warning signal that indicates of collision risk to the warning unit 40.

Thereby, the warning unit 40, as shown in FIG. 3, secondarily warns the driver to assist the driver in more surely recognizing collision risk by displaying a warning light, outputting a warning sound, and outputting vibration based on the second stage warning signal output from the electronic control unit 20 (112). This allows the driver who recognizes collision risk to take an appropriate collision preventing measure, e.g., to release an accelerator pedal or to push a brake pedal.

Then, the electronic control unit 20 judges whether or not the degree of collision risk corresponds to the third stage in which the TTC value is T3 or less (114). In the case of the third stage in which the TTC value is T3 or less, the electronic control unit 20 judges a high degree of collision risk, and outputs a preliminary braking signal to the brake unit 30 while continuously outputting the second stage warning signal that indicates of collision risk to the warning unit 40.

Thereby, the brake unit 30 generates brake force to prevent vehicle collision in response to the preliminary braking signal output from the electronic control unit 20 (116).

In an operation to control deceleration of a vehicle using brake force, as shown in FIG. 3, the brake unit 30 performs pre-braking to control brake force of the vehicle such that a distance between an owner's vehicle and another vehicle in front thereof is maintained at a deceleration value of 0.3 g.

Also, the electronic control unit 20 judges whether or not the degree of collision risk corresponds to the fourth stage in which the TTC value is T4 or less (118). In the case of the fourth stage in which the TTC value is T4 or less, the electronic control unit 20 judges a higher degree of collision than the third stage, and outputs an automatic emergency braking signal to the brake unit 30 while continuously outputting the second stage warning signal that indicates of collision risk to the warning unit 40.

Thereby, the brake unit 30 generates brake force to prevent vehicle collision in response to the automatic emergency braking signal output from the electronic control unit 20 (116).

In an operation to control deceleration of a vehicle using brake force, as shown in FIG. 3, the brake unit 30 performs pre-braking to control brake force of the vehicle such that a distance between an owner's vehicle and another vehicle in front thereof is maintained at a deceleration value of 0.3 g.

In the automatic braking state at a deceleration value of 0.3 g, if the driver steps on the brake pedal based on judgment that collision with a vehicle in front is inevitable, the electronic control unit 20 adaptively determines a brake assist magnitude corresponding to the degree of collision risk in real time, and controls brake force of the brake unit 30 to maintain a deceleration value corresponding to the determined brake assist magnitude.

Thereafter, the electronic control unit 20 judges whether or not the degree of collision risk corresponds to the fifth stage in which the TTC value is T5 or less (122). In the case of the fifth stage in which the TTC value is T5 or less, the electronic control unit 20 judges that the vehicles are about to collide, and continuously outputs the second stage warning signal that indicates of collision risk to the warning unit 40 as well as the automatic emergency braking signal to the brake unit 30.

In addition, the electronic control unit 20 outputs an air bag drive signal to the air bag drive unit 50 to more surely mitigate shock applied to vehicles and drivers upon vehicle collision.

Thereby, the air bag drive unit 50 inflates the external air bag 51 immediately before vehicle collision in response to the air bag drive signal output from the electronic control unit 20, so as to mitigate damage to vehicles and drivers to the maximum extent possible even if vehicle collision occurs.

Although the embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A collision damage mitigation system of a vehicle, the system comprising:
a forward sensor to detect a distance and relative speed between an owner's vehicle and a vehicle in front thereof;
an electronic control unit to judge a degree of collision risk based on a Time-To-Collision (TTC) value upon receiving sensor information transmitted from the forward sensor, the TTC value being obtained by dividing the distance between the owner's vehicle and the vehicle in front thereof by the relative speed therebetewen, and to control implementation of at least one of collision warning, vehicle control, and inflation of an air bag based on the judged degree of collision risk; and
an air bag drive unit to inflate the air bag, immediately before collision between the owner's vehicle and the vehicle in front thereof occurs, in response to an air bag inflation signal for inflation of the air bag from the electronic control unit.

2. The system according to claim 1, further comprising a warning unit to warn a driver of collision risk between the owner's vehicle and the vehicle in front thereof,
wherein the electronic control unit warns of collision risk between the owner's vehicle and the vehicle in front thereof in stages via the warning unit, prior to inflating the air bag based on the judged degree of collision risk.

3. The system according to claim 2, wherein the warning unit implements at least one of a warning light display operation, a warning sound output operation, and a vibration output operation.

4. The system according to claim 2, further comprising a brake unit connected to the electronic control unit to generate brake force,
wherein the electronic control unit controls a braking operation of the brake unit to brake the owner's vehicle while controlling operation of the warning unit, prior to inflating the air bag based on the judged degree of collision risk.

5. A control method of mitigating collision damage to a vehicle, the method comprising:
detecting a distance and relative speed between an owner's vehicle and a vehicle in front thereof using a forward sensor;
judging, by an electronic control unit, a degree of collision risk based on a Time-To-Collision (TTC) value obtained from sensor information detected by the forward sensor, wherein the TTC value is obtained by dividing the distance between the owner's vehicle and the vehicle in front thereof by the relative speed therebetween;
warning a driver of collision risk between the owner's vehicle and the vehicle in front thereof using a warning unit based on the degree of collision risk judged by the electronic control unit;
controlling, by the electronic control unit, the operation of the warning unit and a braking operation of a brake unit to brake the owner's vehicle based on the degree of collision risk judged by the electronic control unit; and
inflating an air bag while implementing at least one of the warning operation of the warning unit and the braking operation of the brake unit based on the degree of collision risk judged by the electronic unit.
